(19) United States
(12) Patent Application Publication
(10) Pub. No.: US 2015/0217440 A1
(43) Pub. Date: Aug. 6, 2015

(54) Modular Hand Tool and Connector Assembly

(71) Applicant: Claude Levesque, Palmyra, ME (US)

(72) Inventor: Claude Levesque, Palmyra, ME (US)

(21) Appl. No.: 14/489,469

(22) Filed: Sep. 18, 2014

Related U.S. Application Data
(60) Provisional application No. 61/933,928, filed on Jan. 31, 2014.

(51) Int. Cl. B25G 3/30

(52) U.S. Cl. CPC B25G 3/30

(57) ABSTRACT

A modular tool construction is provided comprising a tool shaft with a first and second connector assembly that are adapted to removably support tool implements at each end, whereby the tool can take on different tasks without resorting to multiple, single-use tools. The connector assemblies comprise an elongated, male connector member that is adapted to be received by a complimentary female member. The connection between the male and female members aligns the tool shaft with the tool implement. A slidable sleeve is thereafter positioned over the joint and threadably secured thereover. The internal members and the sleeve provide sufficient support to prevent prying and failure at the joint location, while also providing for ease of attachment and removal of different implements. The tool shaft is adapted to comprise a male and a female connector member at opposing ends.

### CROSS REFERENCE TO RELATED APPLICATION

This application claims the benefit of U.S. Provisional Application No. 61/933,928 filed on Jan. 31, 2014. The above identified patent application is herein incorporated by reference in its entirety to provide continuity of disclosure.

### BACKGROUND OF THE INVENTION

1. Field of the Invention

The present invention relates to hand tools and those with interchangeable construction. More specifically, the present invention relates to a tool shaft construction with a universal connector at one or both ends such that the user can interchangeably attach different style handles and tool head attachments thereto.

It is recognized that many tools are necessary when gardening or tending to landscape. Different tasks require different tools to efficiently complete the same, which can sometimes require a user to purchase and transport several tools to a work area. The present invention relates to a modular, all-in-one tool assembly that comprises a tool handle with unique connector ends that can support various tool heads and tool handles therefrom without requiring the user to use other hand tools to assembly or disassemble the same.

A typical homeowner owns dozens of tools, such as shovels, rakes, brooms and other handled tools of various size and construction. These bulky tools can accumulate over time, taking up much needed space in a garage, basement, or other indoor space. To reduce the number of unique tools, a modular and interchangeable tool assembly is provided, wherein a tool handle system is deployed and unique handles and tool heads can be used with each other. This allows the user to purchase unique tool handles or tool heads, without purchasing entirely new tools with their own complete construction.

Specifically, the present invention comprises a tool handle having a first and second end, wherein each end comprises a unique connector assembly. The connector assembly supports a tool head assembly or handle assembly required by a given task and preferred by the user. For instance, the tool may support a specific tool handle and a shovel working end, or alternatively the tool may support a pair of working ends at opposing ends thereof. The connector assembly is one that aligns the two connected members and statically supports the members once connected. Its construction is one of an internal shaft that aligns the two members, whereover a threaded sleeve secures the two members together and prevents excessive prying at the joint. This ensures that the user can apply significant load through the tool handle without bending or failing the connector between the attached tool members. Overall, the present invention provides a system that allows for rapid and efficient interchangeability of tool elements using a single handle.

2. Description of the Prior Art

Devices have been disclosed in the prior art that relate to tool connectors and interchangeable tool assemblies. These include devices that have been patented and published in patent application publications. The following is a list of devices deemed most relevant to the present disclosure, which are herein described for the purposes of highlighting and differentiating the unique aspects of the present invention, and further highlighting the drawbacks existing in the prior art.

One such device in the prior art is U.S. Pat. No. 3,651,533 to Bouras, which discloses a mop head construction that is now relatively common in the art, wherein the mop handle threadably attaches to a threaded member disposed on the mop head upper portion. A clamping plate is disposed along the upper portion and supports the mop bundle, while further supporting and upstanding threaded member that threadably engages the lower end of a mop handle. While providing a mop with a removable head, the Bouras device fails to contemplate a construction that first locks the tool head to the handle before threadably engaging the same. The present invention further provides a handle that can support both interchangeable handles and tool heads.

U.S. Pat. No. 1,882,288 to Lee discloses a combination tool that comprises an elongated tool handle and a lower end that threadably secures to a tool head, similar to the Bouras device. The Lee device contemplates a spading blade attachment that secures to the tool handle by way of the tool handle threaded member and a threaded aperture at the base of the tool head. For similar reasons as the Bouras device, the Lee device fails to contemplate the elements of the present invention.

U.S. Patent Publication No. 2004/0244117 to Huang discloses a gardening tool with multiple, interchangeable heads that secure to an elongated shaft using a common fastener attachment scheme. The fastener attachment scheme comprises a connecting portion that accepts therein the tool handle and fasteners from the tool head. The fasteners are positioned through the interchangeable head and used to secure one of several contemplated tool head designs. While providing some form of interchangeability, the Huang device requires the user to deploy tools to remove and replace tool heads, which is akin to reconstructing or reassembling a tool. The present invention provides a quick connect and disconnect assembly that does not require tools to interchange the tool heads or handles.

U.S. Pat. No. 8,322,764 to Miller discloses a long handled tool with a modular component system for changing the head and handle thereof. The assembly comprises a connector system within a round outer collar, whereby portions are connected and secured using fastener connectors and an internal member that aligns the adjacent parts. Once aligned, a fastener is placed through aligned apertures and threadably secured. Similar to the Huang device, the Miller device requires hand tools to assembly and reconfigure. The present invention utilizes an internal alignment member and an outer, threaded sleeve to secure two portions of the tool together. No additional tools or fasteners are required. The present invention secures the internal alignment member, which may include a spring pin temporary lock, and an external sleeve that threadably secures over the joint.

The present invention provides a modular tool assembly with a unique connector element that supports connection of different tool heads and tool handles without deploying tools or fasteners to secure the same. The connector is sufficiently structured such that the user can exert the same force through the tool as if the tool were a single-purpose assembly, preventing premature failure that is typical of some interchangeable tools. It is submitted that the present invention is substantially divergent in design elements from the prior art, and consequently it is clear that there is a need in the art for an improvement to existing modular tool devices. In this regard the instant invention substantially fulfills these needs.

### SUMMARY OF THE INVENTION

In view of the foregoing disadvantages inherent in the known types of tool assemblies now present in the prior art, the present invention provides a new modular hand tool and connector assembly that can be utilized for providing convenience for the user when utilizing one tool system to accomplish several tasks, wherein multiple tools would otherwise be required.

It is therefore an object of the present invention to provide a new and improved modular hand tool and connector assembly that has all of the advantages of the prior art and none of the disadvantages.

It is another object of the present invention to provide a modular hand tool and connector assembly that comprises a tool shaft that can support different tool implements therefrom, including various tool working ends, tool handles, and additional tool shaft lengths from the tool shaft.

Another object of the present invention is to provide a tool shaft connector assembly that utilizes internal male/female connector members and an external sleeve to statically support the tool implement from the end of the tool shaft and account for load received through the joint during a work activity.

Yet another object of the present invention is to provide a tool shaft connector assembly that utilizes an internal male connector member that engages a female connector member, whereover a sleeve is positioned and threaded into place over the join.

Another object of the present invention is to provide a modular hand tool having a first and second end, whereby the ends comprise a male connector member at one end and a female connector member at an opposing end.

Another object of the present invention is to provide a modular hand tool that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the hand tool of the present invention and a close-up of the connector assembly.

FIG. 2 shows a perspective view of an embodiment of the hand tool, wherein several tool shafts are connected to form an elongated tool having a specific tool implement and tool handle.

FIG. 3 shows a view of the connector assembly of the present invention.

FIG. 4A shows a view of the connector assembly of the present invention.

FIG. 4B shows a view of the connector assembly of the present invention.

FIG. 4C shows a view of the connector assembly of the present invention.

FIG. 5A shows an alternate embodiment of the male connector member of the connector assembly.

FIG. 5B shows an alternate embodiment of the female connector member of the connector assembly.

### DETAILED DESCRIPTION OF THE INVENTION

Reference is made herein to the attached drawings. Like reference numerals are used throughout the drawings to depict like or similar elements of the modular hand tool and connector assembly. For the purposes of presenting a brief and clear description of the present invention, the preferred embodiment will be discussed as used for providing a modular tool that can support various tool implements and form different tool configurations, reducing tool switching and the number of discrete, single-use tools required for a given project. The figures are intended for representative purposes only and should not be considered to be limiting in any respect.

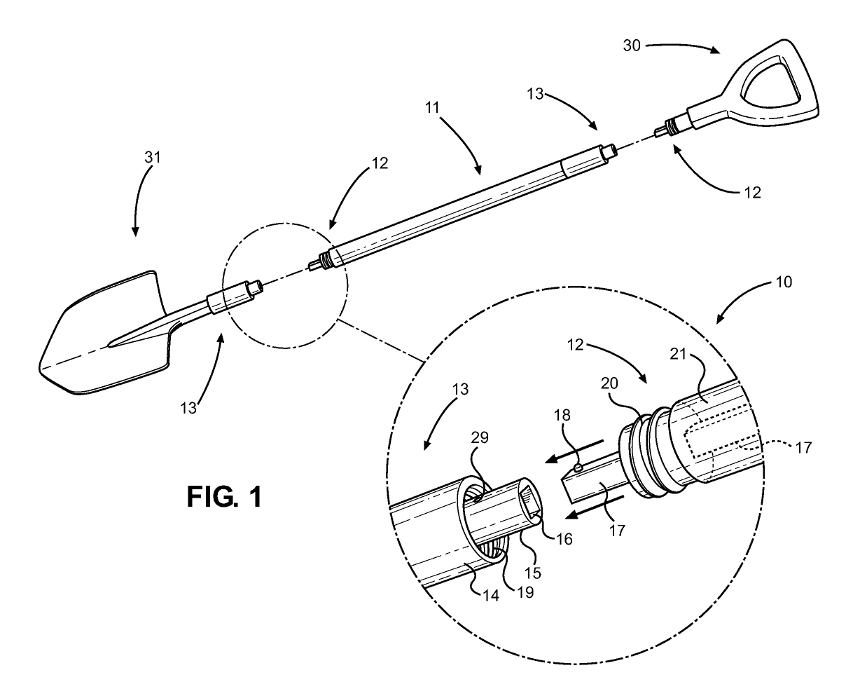

Referring now to FIG. 1, there is shown a perspective view of the modular hand tool and connector assembly of the present invention. The tool comprises a tool shaft 11 having a first end and a second end. Each end forms a portion of a unique tool connector assembly 10 that is used to secure tool implements to the shaft for different tool operations. In this way, the tool can function as multiple tools without requiring additional, single-use tools on a project. Preferably, the tool shaft 11 comprises a male connector end 12 and a female connector end 13 disposed oppositely at the ends of the shaft 11. The male 12 and female 13 connector ends are adapted to join together and be complimentary pairs, wherein the two form the connector assembly 10 of the present invention and secure tool implements to the tool shaft 11 for rugged, operational use. The contemplated tool implements comprise hand tool working ends 31 and tool handles 30 that are commonly deployed for landscaping, construction projects, and other activities in which a user is manually lifting, cutting, moving, or manipulating items in a work area. The tool implements themselves comprise a tool implement end that supports the male or female connector member, and the tool head that comprises the handle or tool working end.

The male connector end 12 comprises an internal shaft forming a male connector member 17 that extends from the end of the tool body 21. The male connector member 17 is preferably supported by the end of the tool body 21 centrally within its interior volume, wherein the member 17 may be cantilevered from the end thereof, or preferably extend through the shaft of the tool body 21 as shown in FIG. 1. This configuration extends the length of the member 17 and prevents prying or failure of the member 17 at the end of the tool body 21. An elongated internal shaft supported therein via a bushing or similar support can withstand the bending at the end of the tool body 21, wherein a cantilevered configuration is more prone to failure. The configuration of the male member 17 may take on either of these two forms.

The male connector member 17 comprises an elongated length exposed from the end of the tool body 21. Adjacent to the terminal end thereof is preferably a locking fastener or spring pin fastener 18. The spring pin 18 may comprise a captive, spring biased ball or similar pinned connection that is adapted to align and secure within an aperture 29 in the female connector member 15. This connection temporarily locks the male 17 and female 15 connector members together, whereover a sliding sleeve 14 is used to secure the joint in a static condition.

The female connector member 15 comprises a similar construction as the male connector member 17, wherein the female member 17 extends outward from its tool body. The end of the female connector member 17 comprises an opening 16 to an internal channel adapted to receive the male connector member 17 therein. The male 17 and female 15 members are aligned and the spring pin secures the two members together. Over the female connector member 15 is a sleeve 14, which is slidable along its tool body. The sleeve 14 comprises an internal threaded surface 19 that is adapted to threadably secure to an externally threaded surface 20 disposed along the tool body 21 supporting the male connector member 17. This allows the sleeve 14 to slide over the connected members and secure the tool bodies of the tool shaft and a tool implement together.

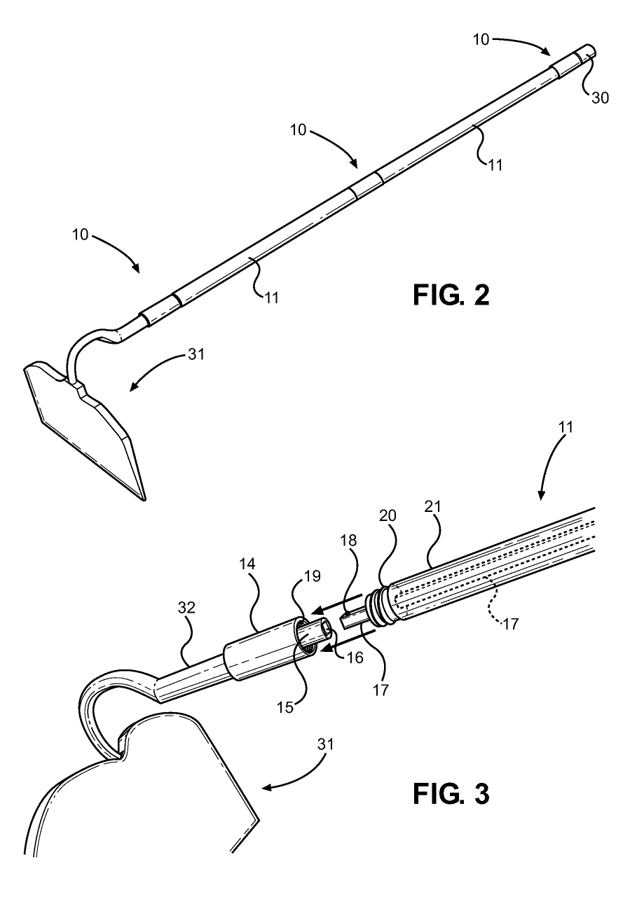

Referring now to FIG. 2, there is shown a view of one configuration of the present invention, wherein a first and second tool shaft 11 is connected to one another to provide for an extended length tool. At the proximal end of the tool is provided a tool handle 30, while the distal end is supporting a tool implement 31 in the form of a garden hoe. Connecting the tool shafts 11 together and the implements 30, 31 to the tool shafts 11 are the connector assemblies 10. The connector assemblies each comprise a male and female connector member and a slidable sleeve that threadably secures over the connectors once joined. Once the connector assemblies 10 are secured, the tool forms a unitary implement that is structurally stable and sufficient for engaging in work activities in which extensive load is placed on the tool and through each of the connector assemblies 10 thereon.

Each of the joints is exposed to substantial shear, bending, axial, and torsion loading. The joints (connector assemblies) are designed to provide a seamless connection between adjacent members without compromising the strength of the tool. The internal members support a majority of this load, while the sleeve is a second load bearing member that prevents prying at the interface between the internal members. Overall, the connector assemblies allow the user to secure various implements together to design a desired tool, wherein the tool can be used in the same manner as single-use tools and without fear of premature failure under rigorous work conditions.

Referring now to FIG. 3, there is shown an illustrative view of a tool implement 31 being secured to the tool shaft 11 using the connector assembly of the present invention. As shown, the tool body 32 of the implement 31 is aligned with the tool body 21 of the tool shaft 11 such that the male 17 and female 15 connector members are aligned and can secure together. The male connector member 17 is placed within the interior 16 of the female connector member 15 and locked into place using the spring pin 18. After the two members are connected, the user slides the threaded sleeve 14over the members and threadable secures the sleeve 14 to the end of the tool shaft 11 using the threaded connections 20, 19. The embodiment of FIG. 3 extends the male connector member 17 within the interior of the tool shaft 11, whereby a bushing or similar support member supports the member 17 centrally therein and at the end of the shaft. Alternatively, the male member 17 may extend from the end of the tool shaft 11 and not extend coaxially within the tool shaft along a substantial portion of its length.

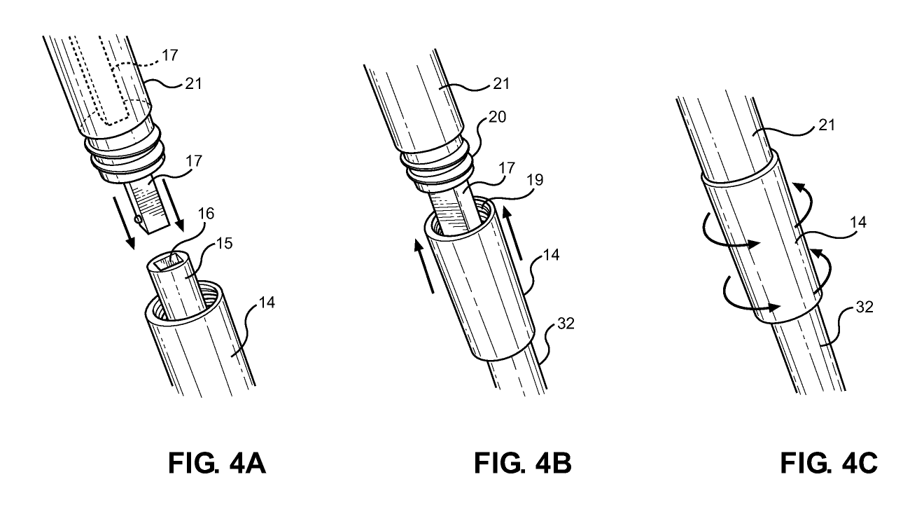

Referring now to FIGS. 4A through 4C, there are shown the steps for securing together the connector assembly of the present invention. As described, the male connector member 17 is secured within the female connector member 15, whereby the interior 16 of the female member 15 is adapted to receive the male member 17 therein. After the two members are secured, the sleeve 14 is positioned over the members and secured thereover. The tool body 21 of the shaft and the tool body 32 of the tool implement are aligned with one another such that the sleeve 14 slides upwards to bridge the gap therebetween. The tool body of one implement comprises a threaded exterior surface 20 while the sleeve 14 comprises a complimentary threaded interior surface. The matching thread pitch of these elements allows the sleeve to threadably secure to the tool body of the adjacent implement, as illustrated in FIG. 4C.

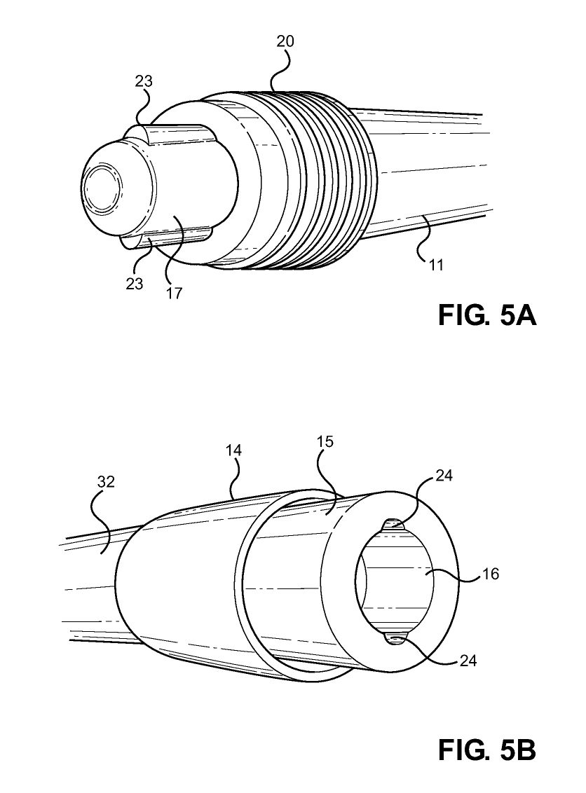

Referring now to FIG. 5A and 5B, there are shown two views of an alternate configuration of the male and female connector members. In this embodiment, the male connector member 17 comprises an elongated length and a shape that is adapted to be received by the open interior 16 of the female connector member 15. However, this embodiment contemplates at least one slide groove member 23 disposed along the length of the male member 17, wherein the groove members 23 are adapted to align with complimentary notches 24 in the female connector member interior 16. The grooves align the two members and prevent relative rotation of the two in a similar fashion as the spring pin of the first embodiment. Both of these structures are alignment and anti-rotation members.

As with the first embodiment, after the two members are connected, the tool body 32 of the implement and the tool body of the tool shaft 11 are aligned. Thereafter, the sleeve 14 is positioned over the members and threadably connected to the external threads 20 disposed on the opposite side of the joint. As previously disclosed, the sleeve 14 includes an interior threaded surface and the sleeve further supports the joint while the tool is being used.

Overall, the present invention provides a modular device that reduces the amount of individual tools needed for a project. The device comprises an elongated tool shaft with unique connector assemblies, whereby various tool implements, tool handles, or extension shafts may be attached thereto using the male/female/sleeve connection. The assembly reduces clutter and necessary tools by providing a single, all-in-one hand tool assembly. The assembly easily switches between different tool tasks and securely supports different tool implements. For instances, one tool head can be swapped for another, longer extensions can be added for reaching the tool head farther from the user, and different style handles can be attached to the hand tool. This eliminates the need to bring multiple, single-use tools to a worksite. Furthermore, once the device is broken down into smaller elements, the assembly can be more easily transported in a single carrying bag for user convenience.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A modular hand tool assembly, comprising:
a tool shaft having an elongated length, a first end, and a second end;
at least one tool implement having a tool body and a tool implement end;
said tool implement end adapted to secure to said first end or said second end using a connector assembly;
said connector assembly comprising a male connector member adapted to be received by a female connector member, and a sleeve slidable over said male connector member and female connector member when connected to one another, and further threadably connected thereover.

2. The modular hand tool assembly of claim 1, wherein said tool implement further comprises a tool head.

3. The modular hand tool assembly of claim 1, wherein said tool implement further comprises a tool handle.

4. The modular hand tool assembly of claim 1, wherein:
said first end of said tool shaft comprises a male connector member and said second end of said tool shaft comprises a female connector member.

5. The modular hand tool assembly of claim 1, wherein:
male connector member comprises an elongated internal shaft within said tool shaft, extending within an internal volume of said tool shaft and coaxially supported therein;
said male connector member extending from said first end;
said male connector member further comprising a spring pin connector adapted to secure within an aperture in said female connector member.

6. The modular hand tool assembly of claim 1, wherein:
male connector member comprises an elongated internal shaft cantilevered from said first end;
said male connector member extending from said first end;
said male connector member further comprising a spring pin connector adapted to secure within an aperture in said female connector member.

7. The modular hand tool assembly of claim 1, wherein:
male connector member comprises an elongated internal shaft within said tool shaft, extending within an internal volume of said tool shaft and coaxially supported therein;
said male connector member extending from said first end;
said male connector member further comprising at least one elongated groove adapted to secure within at least one notch along said female connector member.

8. The modular hand tool assembly of claim 1, wherein:
male connector member comprises an elongated internal shaft cantilevered from said first end;
said male connector member extending from said first end;
said male connector member further comprising at least one elongated groove adapted to secure within at least one notch along said female connector member.

9. The modular hand tool assembly of claim 1, wherein:
said sleeve is slidably secured to said female connector member and comprises an inner threaded surface that is adapted to threadably connect to a threaded external surface adjacent to said male connector member.

10. The modular hand tool assembly of claim 1, wherein:
said sleeve is slidably secured to said male connector member and comprises an inner threaded surface that is adapted to threadably connect to a threaded external surface adjacent to said female connector member.

11. A modular hand tool assembly, comprising:
a tool shaft having an elongated length, a first end, and a second end;
at least one tool implement having a tool body and a tool implement end;
said tool implement end adapted to secure to said first end or said second end using a connector assembly;
said connector assembly comprising a male connector member adapted to be received by a female connector member, and a sleeve slidable over said male connector member and female connector member when connected to one another, and further threadably connected thereover;
said tool implement end comprising one of said female connector members or said male connector members;
said first end and a second end of said tool shaft comprising one or more of said female connector members or said male connector members.

12. The modular hand tool assembly of claim 11, wherein said tool implement further comprises a tool head.

13. The modular hand tool assembly of claim 11, wherein said tool implement further comprises a tool handle.

14. The modular hand tool assembly of claim 11, wherein:
said first end of said tool shaft comprises a male connector member and said second end of said tool shaft comprises a female connector member.

15. The modular hand tool assembly of claim 11, wherein:
male connector member comprises an elongated internal shaft within said tool shaft, extending within an internal volume of said tool shaft and coaxially supported therein;
said male connector member extending from said first end;
said male connector member further comprising a spring pin connector adapted to secure within an aperture in said female connector member.

16. The modular hand tool assembly of claim 11, wherein:
male connector member comprises an elongated internal shaft cantilevered from said first end;
said male connector member extending from said first end;
said male connector member further comprising a spring pin connector adapted to secure within an aperture in said female connector member.

17. The modular hand tool assembly of claim 11, wherein:
male connector member comprises an elongated internal shaft within said tool shaft, extending within an internal volume of said tool shaft and coaxially supported therein;
said male connector member extending from said first end;
said male connector member further comprising at least one elongated groove adapted to secure within at least one notch along said female connector member.

18. The modular hand tool assembly of claim 11, wherein:
male connector member comprises an elongated internal shaft cantilevered from said first end;
said male connector member extending from said first end;
said male connector member further comprising at least one elongated groove adapted to secure within at least one notch along said female connector member.

19. The modular hand tool assembly of claim 11, wherein:
said sleeve is slidably secured to said female connector member and comprises an inner threaded surface that is adapted to threadably connect to a threaded external surface adjacent to said male connector member.

20. The modular hand tool assembly of claim 11, wherein:
said sleeve is slidably secured to said male connector member and comprises an inner threaded surface that is adapted to threadably connect to a threaded external surface adjacent to said female connector member.
